(19) United States
(12) Patent Application Publication
(10) Pub. No.: US 2005/0184702 A1
(43) Pub. Date: Aug. 25, 2005

(54) Battery pack and electronic device

(76) Inventors: Akihiro Suzuki, Tokyo (JP); Yoshito Katagiri, Tokyo (JP); Takashi Fujita, Tokyo (JP)

Correspondence Address: CANTOR COLBURN LLP, 55 Griffin Road South, Bloomfield, CT, 06002, US

(21) Appl. No.: 11/057,797

(22) Filed: Feb. 14, 2005

(30) Foreign Application Priority Data
Feb. 19, 2004 (JP) JP2004-042250

(51) Int. Cl. H02J 7/00

(52) U.S. Cl. 320/107

(57) ABSTRACT

A battery pack which is loaded into a battery pack accommodating chamber of an electronic device, including: an electrical power generating section to supply electrical power to the electronic device; and a battery housing section, housing the electrical power generating section, and having a first concave section on a surface of the battery housing section formed along a loading direction of the battery pack to couple with an engaging section of the battery pack accommodating chamber by an elastic force generated by the engaging section; wherein when the battery pack is placed in a loaded position in the battery pack accommodating chamber, the first concave section is not coupled with the engaging section, and when the battery pack is moved toward an unloading direction from the loaded position, the first concave section is coupled with the engaging section by the elastic force.

### BACKGROUND OF THE INVENTION

The present invention relates to a battery pack and an electronic device, and in particular, to a battery pack which when loaded into the electronic device, is prevented from unexpectedly dropping from the electronic device, and to the electronic device incorporating this battery pack.

In electronic devices, such as an electronic camera, it is common that a disposable battery or a rechargeable battery is loaded in a battery pack accommodating chamber, and used as a power supply means. In cases other than that the battery is charged while loaded in the battery pack accommodating chamber, when remaining electrical power of the loaded battery becomes unadequate, the batteries are removed from the electronic device for changing. For this purpose, an integrated lid, which can be opened or closed by the user, is provided on the battery pack accommodating chamber, whereby the user can change the batteries.

When the user removes the batteries from the battery pack accommodating chamber, it is convenient when the user uses gravity by orienting the lid downward, before opening the lid. However, as soon as the user opens the lid, the batteries can drop from the battery pack accommodating chamber due to gravity, and can step through the users hand so that it brushes against the ground and is likely to be damaged. To counter this problem, a structure using no lid is disclosed in Patent Document 1, wherein a locking mechanism is provided on a cartridge which accommodates the battery, and the cartridge is loaded in the battery pack accommodating chamber. According to this structure, a locking mechanism is released when changing the battery, and then the cartridge can come out from a loaded position, since a locking member further locks the cartridge at the coming-out position, therefore, unexpected dropping is prevented. Additionally, “the loaded position” means the position in which the electrical terminals of the battery pack are in electrical contact with the electrical terminals structured in the battery pack accommodating chamber of the electronic device.

Patent Document 1: J.P.-A No. 2002-42759 (J.P.-A: Japanese Patent Application Publication)

According to the structure described in Patent Document 1, a cartridge is required to house the battery in the battery pack accommodating chamber. However, this structure is not preferable for use, because the electronic device becomes too large though its portability is very important. Further, since the locking mechanism locks the cartridge in two positions, two releasing operations are necessary to remove the battery, which are inconvenient operations. Specifically, when the user wants to change the cartridge, the user takes the electronic device in one hand and tries to release the second lock with the other hand, after which the cartridge is freed, and as soon as the lock is released, the cartridge with the battery may drop.

### SUMMARY OF THE INVENTION

The present invention was achieved for solving the above-described problem, and the objective of the present invention is to provide a battery pack and an electronic device which are prevented from dropping, while at the same time the electronic device is downsized. The objective of the present invention can be attained by the structures described below.

Structure 1

Concerning a battery pack, loaded in a battery pack accommodating chamber of an electronic device which supplies electrical power to the electronic device, a battery housing box and an electronic power generating section integral in the battery housing box are formed, wherein a concave section is formed on a surface of the battery housing box, which is oriented in the direction of insertion of the battery pack, and wherein when the battery pack is placed at the loaded position in the battery pack accommodating chamber, an engaging section formed in the battery pack accommodating chamber does not engage the concave section, and when the battery pack is moved toward the unloading direction from the loaded position, the engaging section engages the concave section by elastic force.

Structure 2

In the battery pack which is loaded at a loaded position in a battery pack accommodating chamber of an electronic device and supplies electrical power to the electronic device, and which can be unloaded from the battery pack accommodating chamber when an openable and closable lid member covering the battery pack accommodating chamber is opened, wherein a battery housing box and an electronic power generating section located in the battery housing box are integrally formed, and a concave section is formed at an outer end of the battery housing box, with respect to the loading direction of the battery pack, and wherein when the lid member has been opened, the engaging section of the battery pack accommodating chamber engages the concave section.

### BRIEF DESCRIPTION OF THE DRAWINGS

FIG. 1 is a perspective view of digital still camera 10, as an electronic device.

FIG. 2 is a perspective view of battery pack 1 relating to the present embodiment.

FIG. 3 is a perspective view of battery pack accommodating chamber 16 of digital still camera 10 in which battery package 1 is loaded.

FIG. 4 is a cross section taken along line D-D on the structure shown in FIG. 3, looking in the direction of the arrows.

FIG. 5 is a perspective view of battery pack accommodating chamber 16 of digital still camera 10 as well as battery package 1.

FIG. 6 is an enlarged cross section of curved blade spring 17.

FIG. 7 is a variation of the engaging section.

### DETAILED DESCRIPTION OF THE PREFERRED EMBODIMENT

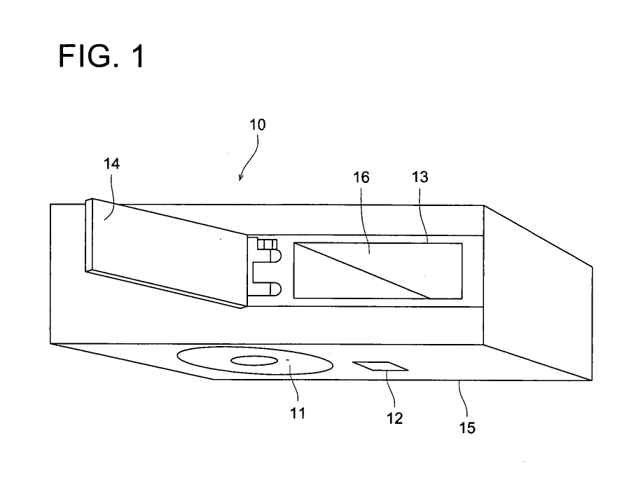

Embodiments of the present invention will now be detailed, referring to the drawings. FIG. 1 is a perspective view of digital still camera 10 as an electronic device. In FIG. 1, digital still camera 10 is provided with picture-taking lens 11 and view finder 12 on the camera front (which is the lower surface in FIG. 1). Further, battery insertion hole 13 for battery pack 1 is formed on the undersurface (the nearest surface in FIG. 1) of digital still camera 10. The interior portion of insertion hole 13 forms battery pack accommodating chamber 16, and insertion hole 13 (that is, battery pack accommodating chamber 16) is covered by lid 14.

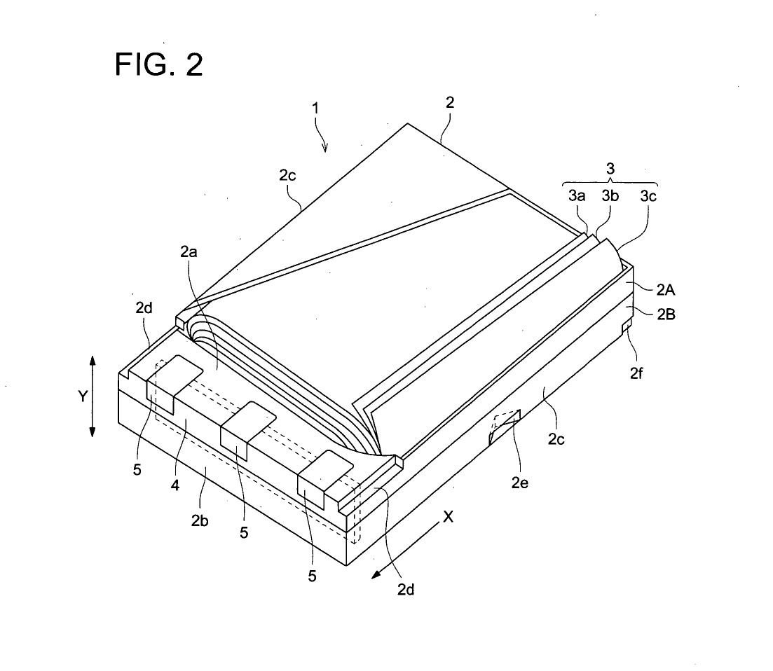

FIG. 2 is a perspective view of battery pack 1 relating to the present embodiment, whose battery housing box is partially removed. In FIG. 2, battery pack 1 includes battery housing box 2, electrical power generating section 3, control circuit section 4 and electrical terminals 5. Battery housing box 2 is just a thin cuboid which is composed of upper cover section 2A and lower plate section 2B. Electrical power generating section 3, control circuit section 4 and electrical terminals 5 are arranged on lower plate section 2B, to which upper cover section 2A is connected. Upper cover section 2A and lower plate section 2B are mechanically fitted or adhered by an adhesive agent, both of which are hard to disassemble, and battery pack 1 is used in this configuration.

Electrical power generating section 3 is, for example, a lithium ion battery which is a type of secondary battery, including three layers which are thin positive electrode plate 3a, thin negative electrode plate 3c and plate separator 3b which is sandwiched between positive electrode plate 3a and negative electrode plate 3c, and further, these three thin layers are rolled in one direction in battery housing box 2. The center of battery roll is oriented in direction to the insertion (direction X in FIG. 2) of battery pack 1.

Control circuit section 4 includes an electrical circuits which control electrical power generating section 3 by cutting off the connection between electrical power generating section 3 and external circuits connected to battery pack 1 via electrical terminals 5 before over-discharging or over-charging occurs to the electrical power generating section, and thereby over-discharging or over-charging can be prevented.

As shown in FIG. 2, three metal terminals (or electrodes) 5 are formed in such a way that they ride and come into being on top surface 2a as well as front surface 2b of battery housing box 2. By placing electrical terminals 5 like this position, effectively used is a space in which both electrical power generating section 3 and control circuit section 4 do not exist.

Concerning the function of electrical terminals 5, in the condition that battery pack 1 is in battery pack accommodating chamber 16 of digital still camera 10, electrical terminals 5 connect electrical power generating section 3 to digital still camera 10 electrically so that electrical power is supplied from battery pack 1, and when discharged battery pack 1 is to be re-charged, battery pack is electrically connected to a charging device, which is not illustrated.

Further on battery housing box 2, notched sections 2d are formed at the upper front corners at which sides 2c, top surface 2a and font surface 2b coincide. That is, front surface 2b of battery housing box 2, which is one end with respect to inserting direction X, is rectangular with its two upper corners being notched. Because of two notched sections 2d, battery pack 1 cannot be erroneously loaded into battery pack accommodating chamber 16.

Additionally, on one of sides 2c which are parallel to the inserting direction (direction X), first concave section 2e is formed. Yet further, being diagonal to notched section 2d, second concave section 2f is formed at the contact point of the back surface and of side 2c. Since first concave section 2e is relatively small, and second concave section 2f is formed at the lower rear corner of battery housing box 2, they barely take space for electrical power generating section 3.

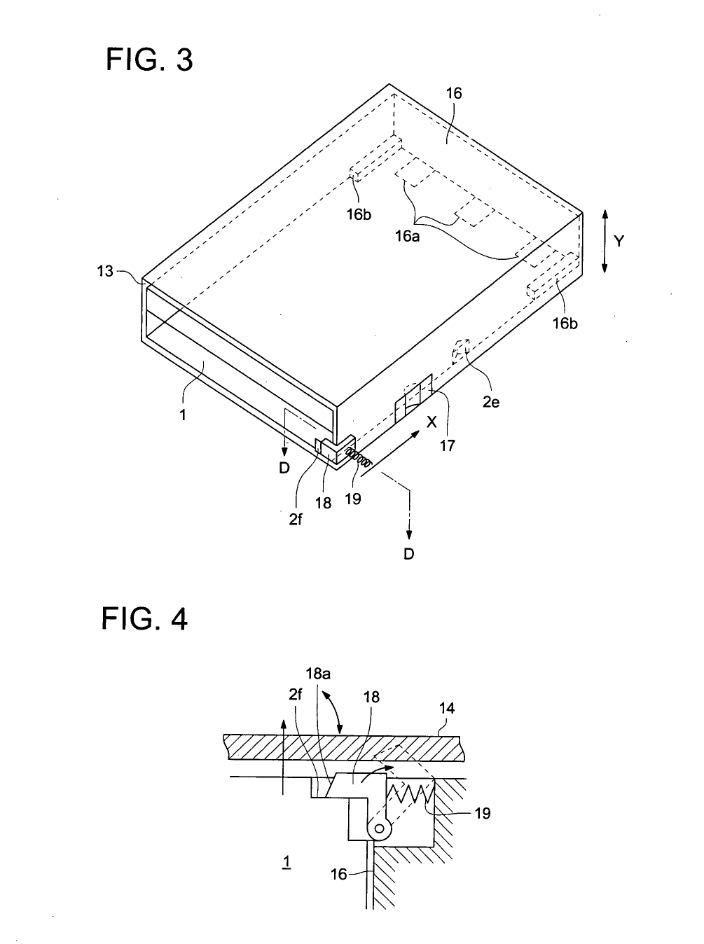

FIG. 3 is a perspective view of battery pack accommodating chamber 16 of digital still camera 10, in which battery pack 1 is housed. At the rear bottom of battery pack accommodating chamber 16, formed are three terminals 16a which, via electrical terminals 5, supply electrical power to digital still camera 10. Also formed are mating projections 16b which project parallel along the interior wall in direction X of battery pack accommodating chamber 1, and mate with notched sections 2d.

Further, under the condition that battery pack 1 is loaded into battery pack accommodating chamber 16, plate spring 17, as a first engaging member is screwed at a position to mate with first concave section 2e on side 2c of battery housing box 2 (in FIG. 2).

FIG. 4 is a cross section taken along line D-D on the lower front corner of the structure shown in FIG. 3, looking in the direction of the appended arrows. In the vicinity of the entrance of battery pack accommodating chamber 16, pivoting L-shaped locking pawl 18 is provided. Locking pawl 18, as the second engaging section, is normally biased by coiled spring 19, so as to close and lock the entrance of battery pack accommodating chamber 16. Tapered surface 18a is formed on one arm of locking pawl 18 so that battery pack 1 can smoothly enter battery pack accommodating chamber 16, and additionally, corresponding to locking pawl 18, a small tapered mating surface is formed on the side of battery pack 1.

When battery pack 1 is inserted into battery pack accommodating chamber 16 of digital still camera 10, the insertion is performed in such direction that while locking pawl 18 rotates against the force of coiled spring 19, front surface 2b, in FIG. 2, is inserted into insertion hole 13 in FIG. 3, so that when fully inserted, notched sections 2d engage mating projections 16b. When battery pack 1 has been inserted into battery pack accommodating chamber 16 of digital still camera 10 in the above-described direction, notched sections 2d are engaged with mating projections 16b, electrical terminals 5 of battery pack 1 contact terminals 16a of digital still camera 10, that is, battery pack 1 has been correctly loaded at a loaded position where battery pack 1 supplies electrical power to digital still camera 10.

As described above, providing notched sections 2d on two surfaces which are parallel and face each other, and additionally providing mating projections 16b in battery pack accommodating chamber 16 to engage notched sections 2d, it is possible to prevent improper seating of battery pack 1, preventing the wrong insertion by the user.

As shown in FIG. 3, under the condition that battery pack 1 has been correctly loaded at the loaded position in battery pack accommodating chamber 16, locking pawl 18, shown by solid line in FIG. 4, is rotated to the engaging position by the force of coiled spring 19, where locking pawl 18 engages second concave section 2f which is formed on battery housing box 2 of battery pack 1. In the engaged condition, even when lid 14 faces downward and the entrance of battery pack accommodating chamber 16 is oriented downward, locking pawl 18 prevents battery pack 1 from dropping by its own weight out of battery pack accommodating chamber 16. Since second concave section 2f is provided on the end of battery pack 1, locking pawl 18 does not project upward in FIG. 4, in addition, locking pawl does not interfere with lid 14, resulting in more downsizing of digital still camera 10.

Yet further, under the condition that battery pack 1 has been correctly loaded in the loaded position in battery pack accommodating chamber 16, since plate spring 17 pushes against side 2c (the surface other than concave section 2e in FIG. 2) of battery housing box 2 of battery pack 1 by an elastic force, battery pack 1 is stably held in battery pack accommodating chamber 16, and thereby, electrical terminals 5 of battery pack 1 would not separate from terminals 16a of digital still camera 10 by any vibration or shock, securing stable power supply.

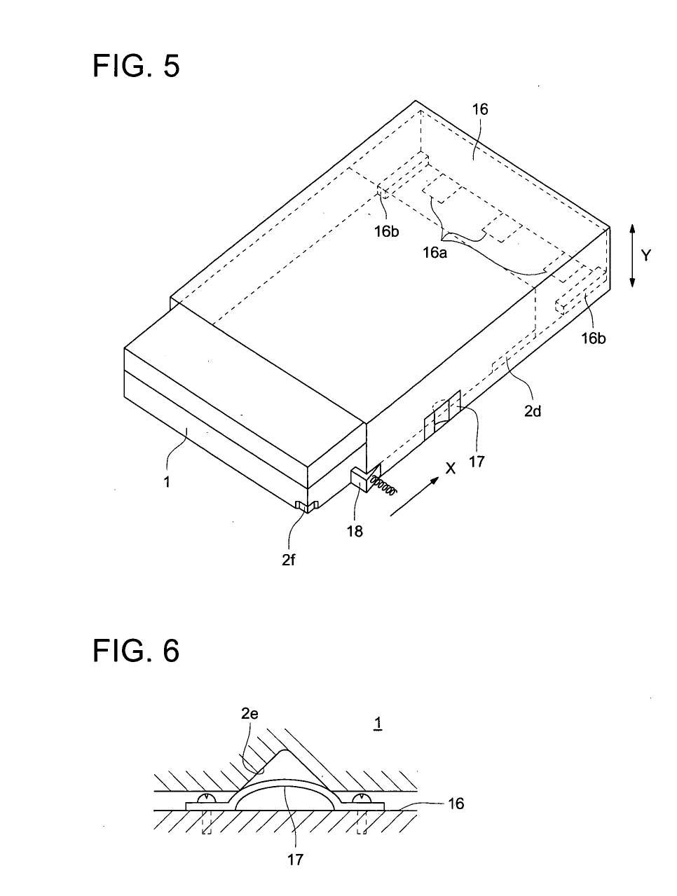

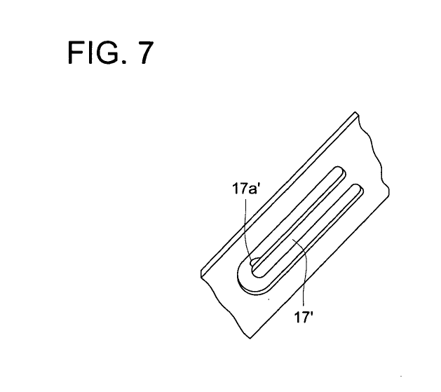

FIG. 5 is a perspective view of battery pack accommodating chamber 16 of digital still camera 10 and partially exposed battery pack 1. FIG. 6 is an enlarged sectional view of plate spring 17 and its adjacent area when engaged with concave section 2e.

In order to remove battery pack 10 from digital still camera 10, after lid 14 is opened, locking pawl 18 is rotated to a waiting position shown by broken lines in FIG. 4 against the force of coiled spring 19. When the opening of battery pack accommodating chamber 16 faces downward, battery pack 1 can move slightly downward due to gravity, but after battery pack 1 moves a predetermined distance in the unloading direction (which is opposite direction X), first concave section 2e of battery housing box 2 engages plate spring 17 which has elastically returned as shown in FIG. 6, that is, battery pack 1 is caught by plate spring 17, and stops when it is partially projected from the opening. The user can then pull on the projected part of battery pack 1, and can safely remove battery pack 1 from digital still camera 10 without dropping it. It is preferable that the engagement between plate spring 17 and first concave section 2e is structured at at least two points on side 2c.

Additionally, first concave section 2e can be shaped to be circled, wedged or trapezoidal in the sectional view. Further the member engaging first concave section 2e is not limited to the plate spring. For example, if the side wall of battery pack accommodating chamber 16 is made of resin, as shown in FIG. 7, it is possible to partially cut the resin side wall, and also form plate section 17′ supported by one end and projection 17a′ on the top surface, which can engage first concave section 2e.

As mentioned above, the present invention has been explained referring to this embodiment, but the invention should not be interpreted to be limited to that above-mentioned embodiment, and needless to say, it is possible to appropriately modify and to improve the embodiment. For example, first concave section 2e may be positioned at numerous places, but when the battery pack 1 is engaged by spring 17, it is preferable that the battery pack 1 projects enough to be seized by the user. Further, the plural layers making up electrical power generating section 3 can be rolled in such a way that a rolled axis is perpendicular to the insertion direction of the battery pack. Still further, it is also possible to employ a cam mechanism which works with lid 14, wherein when lid 14 is closed, the cam mechanism pushes plate spring 17 from behind, and thereby battery pack 1 in the loaded position is firmly held.

### EFFECTS OF THE INVENTION

According to the first embodiment of the present invention of the battery pack, since the battery housing box and the electrical power generating section are integrally formed, and since the concave section is formed on the side surface of the battery pack being in the insertion direction of the battery pack, unexpected dropping of the battery is prevented without employing the cartridge of the conventional art, therefore the first embodiment of the present invention contributes to downsizing of the electronic devices. Further, after the battery pack is moved from the loaded position, the spring member engages the concave section by elastic force. The user then pulls the projected portion of the battery pack out against the elastic force, which makes for very convenient handling. That is, when the user wants to remove the battery pack from the electronic device, it can be surely removed by hand, resulting in more effective prevention of dropping of the battery pack.

The elastic force of the engaging section is preferably greater than the weight of the battery pack and less than the maximum force to be pulled out by the user, and thereby the battery pack can be loaded in the battery pack accommodating chamber and pulled out easily from it by the user.

When the battery pack exists at the loaded position in the battery pack accommodating chamber, the battery pack is firmly held, therefore, attained is firm contact between the respective electrodes of the battery pack and the electronic device, even during vibration.

The above-mentioned electronic device includes the lid which covers or uncovers the battery pack accommodating chamber. When the lid is closed, the force to the battery housing box during engagement increases and is greater than when it is opened, effectively ensuring firm contact between the respective electrodes of the battery pack and the electronic device.

It is preferable to make the engaging member, which engages the concave section of the battery pack, in the battery pack accommodating chamber of the electronic device. Additionally, the electronic device means electronic camera, personal digital assistants, or portable music equipment, but is not limited thereto.

1. A battery pack which is loaded into a battery pack accommodating chamber of an electronic device, comprising:
an electrical power generating section to supply electrical power to the electronic device; and
a battery housing section, housing the electrical power generating section, and having a first concave section on a surface of the battery housing section formed along a loading direction of the battery pack to couple with an engaging section of the battery pack accommodating chamber by an elastic force generated by the engaging section;
wherein when the battery pack is placed in a loaded position in the battery pack accommodating chamber, the first concave section is not coupled with the engaging section, and when the battery pack is moved toward an unloading direction from the loaded position, the first concave section is coupled with the engaging section by the elastic force.

2. The battery pack in claim 1, wherein the elastic force is greater than a force by which the first concave section does not separate from the engaging section even when the weight of the battery pack is added to the battery pack in the unloading direction.

3. The battery pack in claim 1, wherein the battery housing section further has a second concave section to couple with a locking section of the battery pack accommodating chamber of the electronic device.

4. The battery pack in claim 1, wherein the electrical power generating section includes a plurality of stacked layers rolled around a rolling axis oriented to the loading direction of the battery pack.

5. An electronic device, comprising
a battery pack accommodating chamber for the battery pack of claim 1, including an engaging section to couple with the first concave section of the battery pack.

6. The electronic device in claim 5, wherein when the battery pack is loaded and covered by a lid of the electronic device, the engaging section pushes the battery housing section with pressure greater than when the lid is opened.

7. The electronic device in claim 5, further comprising an elastic power generating section in the battery pack accommodating chamber.

8. The electronic device in claim 5, further comprising
a locking section to lock the second concave section of the battery pack.
